(19) United States
(12) Patent Application Publication
(10) Pub. No.: US 2006/0097092 A1
(43) Pub. Date: May 11, 2006

(54) Conveying system, particularly for cement

(76) Inventor: Gerhard Baumann, Schwandorf (DE)

Correspondence Address: Jordan & Hamburg, 122 East 42nd Street, New York, NY, 10166, US

(21) Appl. No.: 10/543,782

(22) PCT Filed: Jan. 20, 2004
(86) PCT No.: PCT/EP04/00373

§ 371 Date: Oct. 26, 2005

(30) Foreign Application Priority Data
Jan. 29, 2003 (DE) 103 03 559.1

(51) Int. Cl. B02C 19/00

(52) U.S. Cl. 241/101.2

(57) ABSTRACT

The invention relates to a conveying system for powdery products, particularly cement, which are placed in packages, preferably sacks. The aim of the invention is to improve this conveying system whereby simplifying the handling when obtaining and providing the products in packages. To this end, a holding unit is provided to which the unopened packages containing the product can be supplied. A comminution machine is connected down from said holding unit and serves to comminute the packages. A conveying device and/or a conveying unit is/are located down from said comminution machine and serve(s) to convey the product together with the package parts leaving the comminution machine.

### BACKGROUND OF THE INVENTION

The invention relates to a conveying system for powdery products, especially cement, that can be transported in sacks.

It is known that powdery products, especially cement, can be transported in silos or other containers as well as in sacks as so-called sack goods. Transport in silos or with silo vehicles is quite problematic in regions that do not have adequate infrastructure for large silo vehicles. Thus, for example, it is not possible simply to deliver cement to major construction sites in remote regions using conventional large silo vehicles when there is a lack of suitable roads. In addition, experience demonstrates that construction of suitable transport systems or transport arteries is quite complex and frequently undesired, for instance from an environmental perspective.

Furthermore, there are difficulties when erecting large cement silos is not permitted at the construction site, for instance in protected areas. On the other hand, delivering cement as sack goods requires additional complexity in terms of opening and emptying the sacks, and the problems caused by cement swirling in the air and associated contamination of the environment as well as the loss of not inconsiderable residual quantities of cement in the sacks have proved disadvantageous. Moreover, once the sacks have been emptied, disposing of them as waste products constitutes another complicating factor.

### BRIEF SUMMARY OF THE INVENTION

The object of the invention is therefore to avoid the aforesaid disadvantages and to simplify handling during procurement and provision of the products in packagings, in particular sacks or as sack goods. The conveying system should have a simple design and functionally assured construction and should facilitate economic operation. Moreover, conveyance and use that handles the powdery product gently, especially cement, should be assured. Furthermore, additional complexity in terms of the disposal of the packagings or sacks should be avoided.

The inventive conveying system is distinguished by a simple functionally appropriate design and simplifies handling during procurement of the powdery product, in particular cement, by means of sack goods and also simplifies easy and cost-effective disposal of the sacks or packagings in general. The inventive conveying system contains a comminution machine by means of which the packagings are comminuted such that their comminuted components are integrated into the subsequent processing and in particular are worked into the concrete.

The sacks that have not been opened in advance and that are supplied to the conveying system together with the product disposed in the sacks are introduced into the conveying system, whereby the sacks are comminuted and thus also opened by means of the comminution machine. The sacks with their contents are processed by means of the comminution machine so that subsequently the comminuted components of the sacks can be further processed and in particular mixed into the cement. The comminuted packagings are integrated into the subsequent process and then in particular worked into the concrete.

Loss of residual quantities of product with the packaging is avoided and there is no need to dispose of the packaging separately. The system thus contributes to relieving the burden on the environment in terms of disposing of the residual material and protects raw material resources. The packagings do not have to be opened individually, which results in not inconsiderable savings in work and time. The conveying system is employed inventively for any powdery products that can be transported for use, in particular as sack goods, whereby at this juncture, apart from cement, mention should be made of products from the chemical industry, for instance granulates and bulk goods of all types that can especially be conveyed pneumatically. Powdery products in this context are also products that are coarser than e.g. cement, such as granulates.

If the conveying system is used in the production of concrete, quite cost-effective cement supply is assured in particular at temporary major construction sites and it is not necessary to use special silo vehicles. For instance, approx. 360 t cement can be conveyed in a 24-hour operation, which corresponds to a solid concrete yield of approx. 1200 t per day. Once the major construction site is completed, the conveying system, which is called a cement supply station or discharge and filling station, is able to ensure the supply of cement without any problems for years thereafter. Furthermore, the inventive conveying system can be employed in small preparation systems where the erection of large cement silos is not permitted, for instance in protected areas. The conveying system can also assure the cement supply when infrastructure is inadequate, especially when employed in Third World countries in which it is not practically possible to obtain cement in silos.

In addition, it is particularly significant that the inventive conveying system can be simply transported in a simple manner due to the frame that receives the components to be described in the following, especially the exterior dimensions of the conveying system and/or of the frame do not surpass the exterior dimensions of a container and thus permit transport on any truck or low loader without a special permit. Advantageously, the exterior dimensions of the conveying system and/or its frame correspond to those of a standardized container, specifically especially with a length of 6 m, width of 2.44 m, and height of 3 m. The conveying system can be stacked like a container and thus facilitates space-saving transport by sea to assure delivery worldwide. Construction and transport are rendered substantially easier due to the inventive conveying system being designed like a container.

### BRIEF DESCRIPTION OF THE DRAWINGS

The invention is described in greater detail in the following using the exemplary embodiments illustrated in the drawings, without this resulting in restrictions, in which:

FIG. 1 illustrates the conveying system in principle;

FIGS. 2, 3 are side elevations of a first exemplary embodiment;

FIGS. 4, 5 are side elevations of another exemplary embodiment with a pallet elevator; and

FIG. 6 is an elevation of the conveying system in accordance with FIG. 4, but without the pallet elevator.

### DETAILED DESCRIPTION OF THE INVENTION

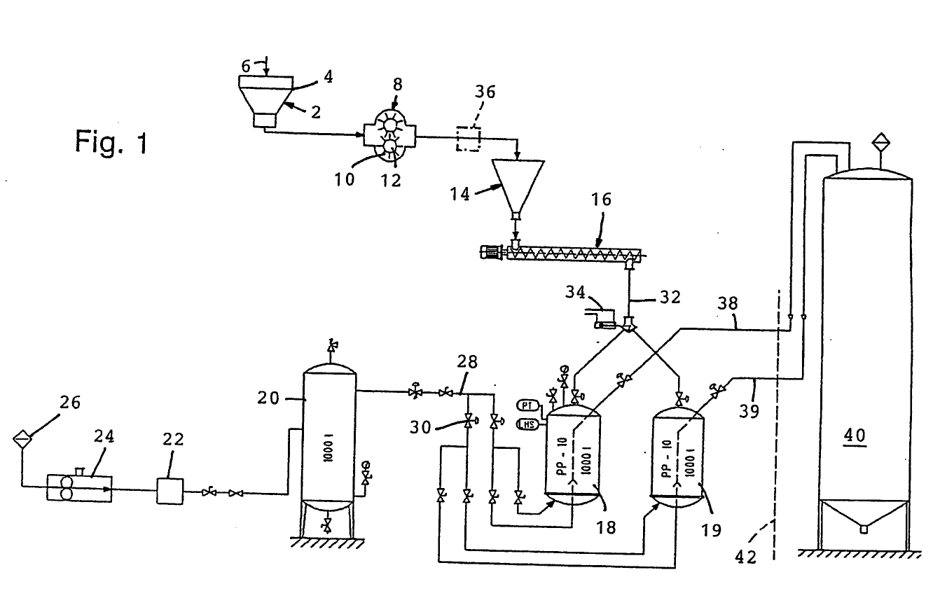

FIG. 1 illustrates the principle of the inventive conveying system with a receiving unit 2 that preferably includes a funnel 4 or is embodied as one. The products, delivered and provided in packagings, in particular sacks, are delivered into the receiving unit 2, specifically with the packagings, which preferably have not been opened in advance. From the receiving unit 2, the packagings and their contents travel to a comminution machine 8 that is usefully arranged directly below the receiving unit 2. The comminution machine 8 includes cutting elements 10 such as knives or the like that are arranged and designed such that the packagings are comminuted, whereby the products previously contained therein, such as in particular cement, are released.

The comminution machine 8 and/or its cutting elements 10 are embodied and arranged such that the packagings can be separated and/or torn into a plurality of small pieces, whereby their exterior dimensions are preferably at least primarily on the order of magnitude of a maximum of a few centimeters and/or their surface areas are at least primarily on the order of magnitude of a few square centimeters. The comminution machine 8 and/or its cutting elements 10 are usefully matched to the requirements for the product, in particular cement, in terms of further processing, in particular for concrete.

Thus, in practical tests it could be determined that the packaging parts worked into the concrete are not associated with any negative effects in terms of quality when the edge lengths are up to 5 cm, preferably up to 3 cm, and in particular up to 2 cm. The comminution machine 8 preferably contains at least two rotating cutting units 12 that are driven by means of a preferably electric drive motor (not illustrated).

Downstream of the comminution machine 8 is a transfer device 14 that here is embodied preferably as a transfer funnel that is arranged below the comminution machine 8 and that is joined in particular securely thereto. The product and the packaging parts blended therewith are fed by means of the transfer device 14 to a conveyor unit 16 that is embodied in particular as a metering spiral conveyor 16 or that includes one. Downstream of the conveyor device 16 is at least one conveyor unit 18, 19 that is preferably embodied as a pressure vessel conveyor.

System output can be prespecified advantageously by specifying the number and/or size of the conveyor units or pressure vessel conveyors 18, 19. Thus for instance in a cement system with a single pressure vessel conveyor of 1000 liters, a system output of 10 t/h can be prespecified and when a second pressure vessel conveyor is employed a system output of 20 t/h can be specified. In addition, the pressure vessel conveyor(s) 18, 19 is or are preferably embodied as balances. As can be seen, upstream of the pressure vessel conveyors 18, 19 is an air container 20 to which the air drawn through an air filter 26 is fed as compressed air via a water separator 22 and compressor 24 through appropriate piping.

The air container 20 communicates with the pressure vessel containers 18, 19 via appropriate piping 28 that contains valves as is known, as illustrated. If more than one conveyor unit or pressure vessel conveyor are present, advantageously provided between these and the conveyor device 16, in the connecting line(s) 32, is a distribution unit 34 that is embodied in accordance with the drawing in particular as a two-way or multi-way distribution in order to selectively feed the product with the packaging parts to the one or the other conveyor unit 18, 19.

In addition, in one alternative special embodiment of the invention a cleaning unit 36, indicated with a dashed line, can be preferably downstream of the comminution machine 8. This cleaning unit 36 contains suitable means, such as rakes or coarse sieves or filters, for separating out in particular relatively large or coarse pieces of packaging from the actual product to be conveyed. Advantageously the cleaning unit 36 is embodied such that it is possible to perform self-actuated and/or automatic cleaning of the aforesaid means in order to assure their proper cleaning function even in continuous operations.

The at least one conveyor unit 18, 19 includes an output line 38, 39 for connecting and for preferably pneumatic further conveyance, in particular to a silo 40 or other storage unit. As indicated with the dashed line 42, the silo 40 does not belong to the inventive conveying system. In accordance with the above description, the inventive conveying system is embodied as a discharge and filling station for powdery or granular products that are supplied in packagings and that can be conveyed pneumatically.

It should be established that, instead of the embodiment described in the forgoing, in the framework of the invention the conveying system and/or cement sack discharge and filling station can also be employed for other powdery and pneumatically conveyable products that can be transported and provided as sack goods or in packagings. What is essential is that the packagings are comminuted and integrated into the further process and that they are subsequently worked into the final product.

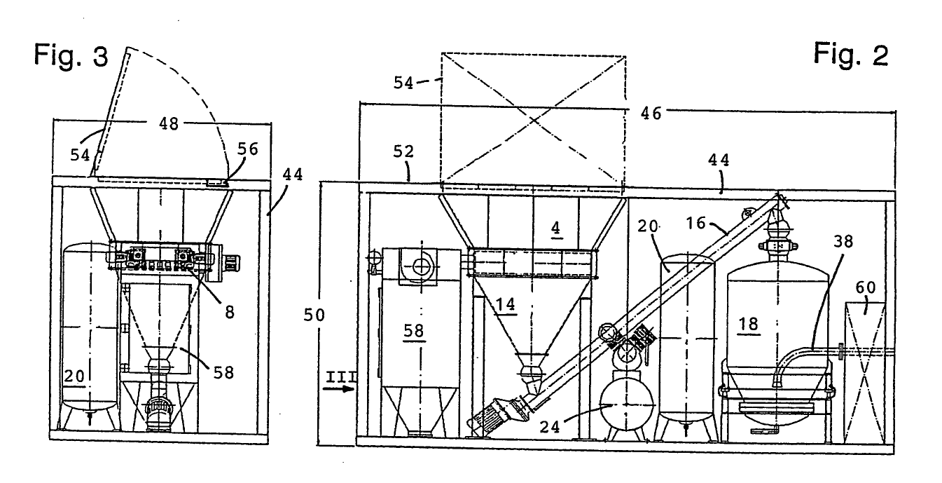

FIG. 2 is a side elevation of the conveying system and FIG. 3 is a view in the direction of the arrow III in accordance with FIG. 2. The conveying system includes a frame 44 that is designed such that the components described above are combined in one compact unit or are integrated into one compact unit. The conveying system and in particular the aforesaid frame 44 are designed such that they conform to the exterior dimensions of a standardized container. The exterior dimensions of the conveying system and the frame are preferably as follows: length 46=6 m, width 48=2.44 m, height 50=3 m.

Thus the conveying system is afforded a high degree of flexibility and can be transported with no problem with any truck or low loader, specifically without a special permit, and is stackable like a container. Furthermore, due to the container-like design, space-saving transport by sea is possible for assuring world-wide delivery with no problem.

The frame 44 is advantageously provided with a roof 52 above. In addition, a pivotable cover 54 is allocated to the receiving unit 2 or the funnel 4, specifically thereabove. The cover 54 is secured against the risk of accidents by means of a securing element 56 that is advantageously embodied as a coded security limit switch and/or in particular is arranged such that the system cannot be operated unless the cover 54 is closed. The security element 56 is in particular arranged flush with the upper edge of the receiving unit 2 or the funnel 4. Arranged below the funnel 4, which is also characterized as a sack funnel, is the comminution machine 8 and thereunder is arranged the transfer funnel 14.

With respect to the creation of dust that is to be expected, in order to prevent components of the product from escaping into the environment an aeration device 58 is advantageously provided in the area of the comminution machine 8. It should be stated here that, apart from the upper opening of the receiving unit 2 and the output line, the various components are sealed to the outside and/or are sealed securely to one another in order to prevent the undesired escape of the powdery product to the outside. Thus the inventive system is a system that is closed to the outside, relative to the conveying flow of the product, with which product provided in closed packagings is conveyed from the receiving unit 2 through the comminution machine 8 to the output line or lines (38, 39) and into a silo 40 or the like that is also sealingly attached thereto.

Furthermore a control cabinet 60 is arranged in the frame 44, usefully in a control cabinet. The complete process from feeding the packaged product into the receiving unit 2 to blowing it out through the output line 38 or blowing it into the downstream silo is controlled and/or regulated and assured by means of the control unit. The above explanations for FIG. 1 apply with respect to the other components.

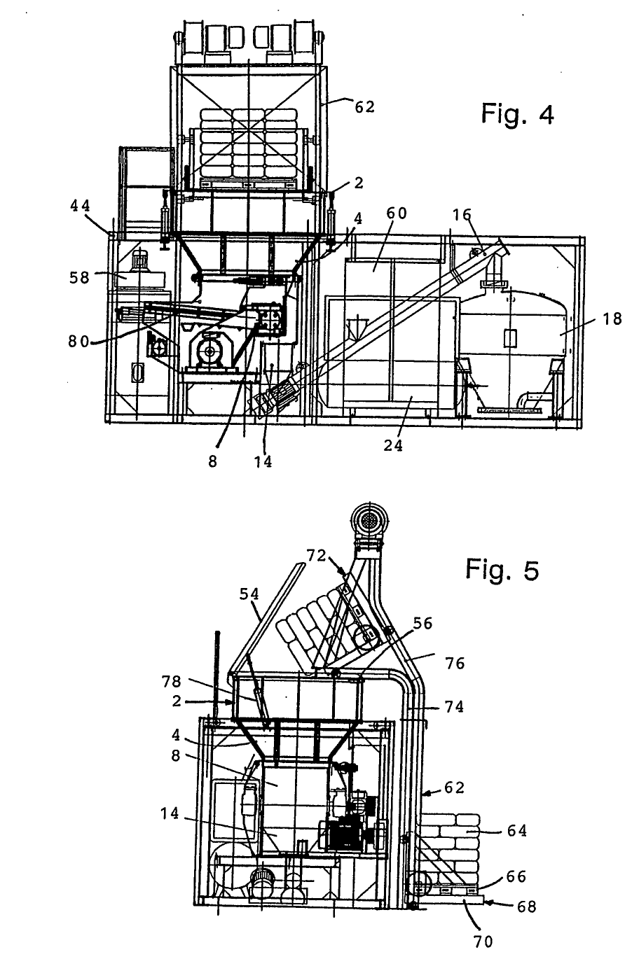

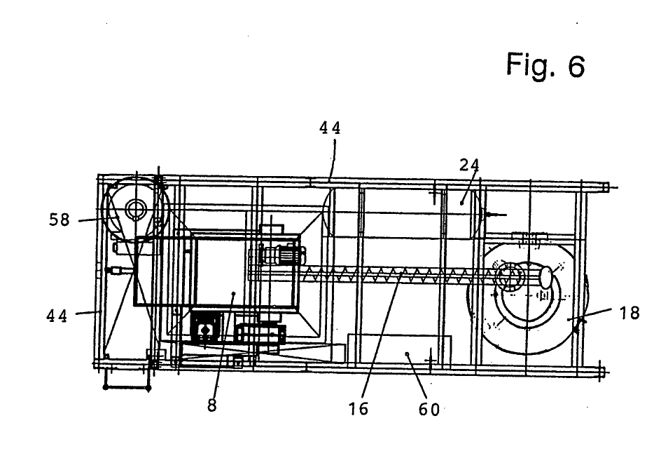

FIGS. 4 and 5 are side elevations and FIG. 6 is a top view of another exemplary embodiment of the conveying system that is combined with an elevator 62, in particular a pallet elevator. The pallet elevator 62 is arranged on the longitudinal side of the conveying system and usefully makes it possible to feed the sacks 64 that are in particular filled with cement. In accordance with FIG. 4, arranged beneath the funnel 4 is a loading unit 80 to which the individual sacks 64 travel. By means of the loading unit 80 the unopened packagings or sacks are fed to the comminution machine 8 to be torn apart or comminuted.

As can be seen in particular from FIG. 5, a pallet 66, upon which a number of cement sacks 64 is stacked, is first brought into the lower position 68 of the pallet bearer 70 movably arranged in the pallet elevator 62, for instance by means of a fork lift, and is then conveyed to an upper position 72. The pallet elevator 62 includes guide rails 74, 76 such that in the upper position 72 the pallet bearer 70 is pivoted or tipped and the cement sacks 64 travel from above into the receiving unit 2 and the funnel 4. The lid 54 pivotably arranged on the upper edge of the receiving unit 2 is open. Subsequently the lid 54 is closed, preferably by means of an actuating unit 78, whereby by means of the previously explained securing element 56 a signal is provided in a suitable manner to the control unit 60 via which the process described above is controlled and/or regulated.

The present invention may be embodied in other specific forms without departing from its spirit or essential characteristics. The described embodiments are to be considered in all respects only as illustrative and not as restrictive. The scope of the invention is, therefore, indicated by the appended claims and their combination in whole or in part rather than by the foregoing description. All changes that come within the meaning and range of equivalency of the claims are to be embraced within their scope.

1-9. (canceled)

10. A system for conveying unopened packagings of powdery products, comprising:
a receiving unit for receiving said unopened packagings;
a comminution machine for comminuting said packagings, said comminution machine being disposed downstream of said receiving unit; and
a conveyor unit for conveying said product and said packaging parts exiting from said comminution machine, said conveyor unit being disposed downstream of said comminution machine and,
said conveyor unit being a pressure vessel unit; and
said receiving unit, said comminution machine, and said conveyor unit being disposed within a frame.

11. The conveying system of claim 10, further comprising:
a funnel and/or opening disposed above said receiving unit;
a cover for covering said funnel and/or opening; and
the packages being provided to said receiving unit through said funnel and/or opening.

12. The conveying system of claim 10, wherein said comminution machine includes cutting elements and/or at least one rotatably arranged cutting unit for opening and comminuting said packages.

13. The conveying system of claim 10, wherein a conveyor device is disposed between said comminution machine and said conveyor unit, said conveyor device being a spiral conveyor or metering spiral conveyor.

14. The conveying system of claim 10, further comprising an output line, said output line conveying said product and said parts of said packaging into a silo.

15. The conveying system of claim 10, wherein said conveyor unit further comprises a balance.

16. The conveying system of claim 10, wherein exterior dimensions of said the frame are prespecified having a length of 6 m, a width of 2.44 m, and a height of 3 m.

17. The conveying system of claim 10, further comprising an elevator for conveying the packages to said receiving unit.

18. The conveyor system of claim 17, wherein said elevator is a pallet elevator.

19. The conveying system of claim 18, wherein:
said pallet elevator includes a pallet bearer, said pallet bearer being movable to said receiving unit on guide rails; and
said pallet bearer being tiltable towards said funnel and/or opening for providing said packages into said receiving unit.
